(19) United States
(12) Patent Application Publication
(10) Pub. No.: US 2023/0151648 A1
(43) Pub. Date: May 18, 2023

(54) STORAGE DEVICE WITH ROTATABLE LATCHING MECHANISM

(71) Applicant: Robert B. Abbott, Spokane, WA (US)

(72) Inventor: Robert B. Abbott, Spokane, WA (US)

(21) Appl. No.: 17/528,548

(22) Filed: Nov. 17, 2021

(51) Int. Cl. E05B 79/10; E05B 47/00

(52) U.S. Cl. CPC E05B 79/10; E05B 47/004; E05B 47/0046; E05B 2047/0074

(57) ABSTRACT

A storage device includes a housing defining a channel, a receptacle, and a first passage. The housing further includes a first magnetic element. A rotatable member is positioned within the receptacle, and the rotatable member is rotatably coupled to the housing and moveable between a first position and a second position. The rotatable member includes a second magnetic element that engages with the first magnetic element in the first position, a third magnetic element that engages with the first magnetic element in the second position, a notch, and a second passage. A cover is at least partially disposed over the housing and the rotatable member. A pin is at least partially disposed within the first passage and within the second passage. The rotatable member is rotatable about an axis extending though the pin.

### BACKGROUND

Hangers, shelfs, racks, and other like devices are used to hold or otherwise secure objects. Such devices, for example, may secure objects to walls or other surfaces. In some instances, the objects may hang or rest from or on the devices. Moreover, the devices may include clips, members, or other mechanism(s) that engage with the object. Such mechanism(s) may assist in securing the object within the device. However, the mechanism(s) are often crude, fragile, and are prone to failure. Moreover, such mechanism(s) may damage (e.g., wear, abrase, etc.) the object.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features. The systems depicted in the accompanying figures are not to scale and components within the figures may be depicted not to scale with each other.

FIG. 1 illustrates an example storage device having a latching mechanism, showing the storage device in an unlocked state for receiving an object, according to an example of the present disclosure.

FIG. 2 illustrates the storage device of FIG. 1, showing the storage device in a locked state for securing the object, according to an example of the present disclosure.

FIG. 3A illustrates a first end view of the storage device of FIG. 1, according to an example of the present disclosure.

FIG. 3B illustrates a second end view of the storage device of FIG. 1, according to an example of the present disclosure.

FIG. 4 illustrates an exploded view of the storage device of FIG. 1, showing example components of the storage device, according to an example of the present disclosure.

FIG. 5 illustrates an example housing of the storage device of FIG. 1, according to an example of the present disclosure.

FIG. 6 illustrates an example rotatable member of the storage device of FIG. 1, according to an example of the present disclosure.

FIG. 7A illustrates the storage device of FIG. 1 in the unlocked state, according to an example of the present disclosure.

FIG. 7B illustrates the storage device of FIG. 1 in the locked state, according to an example of the present disclosure.

FIG. 8 illustrates a storage device having multiple latching mechanism, according to an example of the present disclosure.

FIG. 9 illustrates multiple storage devices being used to secure an object, according to an example of the present disclosure.

### DETAILED DESCRIPTION

This disclosure is directed, at least in part, to a storage device having a locking mechanism configured to hold, secure, or otherwise store an object. In some instances, the storage device includes a housing and a rotatable member that rotationally engages within the housing. The housing defines a channel within which the object is secured, and the rotatable member is configured to rotate to secure the object within the channel. The rotatable member transitions between a first position and a second position. The first position may correspond to an unlocked state of the storage device, while the second position may correspond to a locked state of the storage device. In the first position, the rotatable member is configured to accept the object for storage, such as a pool cue. Application of a first force (e.g., push) on the rotatable member causes the rotatable member to transition from the first position to the second position. In the second position, the object is secured within the storage device. Conversely, application of an opposite second force (e.g., pull) causes the rotatable member to transition from the second position to the first position. In the first position, the object is removable from the storage device. As such, the rotatable member may toggle between the first position and the second position to provide a convenient way to secure the object. Additionally, the toggling nature of the rotatable member permits the object to be quickly secured and retrievable from the storage device.

The housing includes a socket, cutout, or other receptacle within which the rotatable member engages. The rotatable member is rotationally coupled to the housing and is configured to rotate about a rotational axis for transitioning between the first position and the second position. The rotatable member, or a portion thereof, is at least partially disposed within the channel such that the rotatable member is capable of receiving the object and moving between the first position and the second position.

In some instances, the rotatable member includes a cutout, indentation, or other notch that receives and engages with the object. For example, continuing with the above example, the notch may receive at least a portion of the pool cue, such as a handle or portion of a shaft of the pool cue. In some instances, the rotatable member is circular, ovular, square, and/or any other shape capable of being rotatably mounted to the housing. The receptacle of the housing is complimentary to receive the rotatable member.

In some instances, magnetic elements are used to secure the object within the storage device and hold the rotational member in the first position and the second position, respectively. The magnetic elements may be disposed on, in, and/or within the housing and the rotatable disc. For example, the housing may include a first magnetic element that engages (e.g., attracts) with a second magnetic element and a third magnetic element of the rotatable member. In some instances, the rotatable member rotates in a first direction (e.g., counterclockwise) from the first position to the second position, and rotates in a second direction (e.g., clockwise) from the second position to the first position. Given the positioning of the magnetic elements, the first magnetic element remains stationary during rotation of the rotating member, while the second magnetic element and the third magnetic element are movable with the rotating member.

In the first position, the first magnetic element and the second magnetic element engage. This engagement secures the rotatable member in the first position such that the rotatable member is held open to receive the object. However, application of the first force may overcome the engagement between the first magnetic element and the second magnetic element such that the rotatable member is capable of transitioning to the second position. For example, while holding the object, such as a handle of the pool cue, a user may press the pool cue into the notch of the rotatable member. This pressing nature causes the rotatable member to rotate and transition to the second position. In the second position, the first magnetic element engages with the third magnetic element to secure the rotatable member in the second position. Application of the second force, such as pulling on the handle of the pool cue, imparts a force to the rotatable member. When the force overcomes the engagement between the first magnetic element and the third magnetic element, the rotatable member transitions to the first position. In turn, the object may be removed from the storage device.

The magnetic elements provide a snap-like, toggle, or clasping feel when securing the object within the storage device. For example, as the rotatable member rotates towards the second position and the first magnetic element disengages with the second magnetic element, further rotation causes an attraction between the first magnetic element and the third magnetic element. Therein, the attraction between the first magnetic element and the third magnetic element causes the rotatable member to snap to the second position and secure the object within the storage device. Contrarily, when transitioning to the first position, an attraction between the first magnetic element and the second magnetic element causes the rotatable member to snap to the first position and unlock the object from the storage device.

in some instances, more than one storage device may be utilized for securing an object. For example, a first storage device may couple to a wall, counter, cabinet, or other surface using fasteners, brackets, and so forth. A second storage device, spaced vertically below the first storage device, may also couple to the wall. Both of the storage devices may act to secure the object. For example, the first storage device may receive and secure a first end of the pool cue, while the second storage device may receive and secure a second end of the pool cue. The first storage device and the second storage device may respectively lock and unlock to enable the pool cue to be secured and removed. Additionally, in some instances, the storage device may be configured to horizontally hold the object or hold the object at angle. In some instances, a single storage device may include more than one rotatable member and a corresponding channel that are placed end to end. As such, a storage device may be configured to hold an number of objects.

Although the discussion herein relates to securing a pool cue within the storage device, the storage device is not limited to such applications and/or objects. For example, the storage device may secure objects with handles (e.g., broom, shovel, utensil, etc.), objects with shafts (e.g., piping, conduit, etc.), or other objects with members that are capable of being engaged (e.g., flanges, lever, arms, etc.). In such instances, the notch may be correspondingly sized to receive the object or a portion of the object being grasped.

In some instances, a lock may secure the latching mechanism in the closed position to prevent removal of the object from the storage device. The lock, for example, may be disposed through the rotatable member and/or the housing to prevent rotation of the rotatable member (e.g., from the second position to the first position). Other locks, however, may be used to secure the object within the storage device and prevent removal of the object. For example, a bar or strut may be secured, and locked, over the channel of the storage device to prevent removal of the object.

Additionally, in some instances, a biasing member (e.g., a spring) may assist in providing rotational movement of the rotatable member. For example, the biasing member may provide passive actuation to the rotatable member between the unlocked state and/or the locked state.

The present disclosure provides an overall understanding of the principles of the structure, function, device, and system disclosed herein. One or more examples of the present disclosure are illustrated in the accompanying drawings. Those of ordinary skill in the art will understand that the devices and/or the systems specifically described herein and illustrated in the accompanying drawings are non-limiting examples. The features illustrated or described in connection with one example may be combined with the features of other examples. Such modifications and variations are intended to be included within the scope of the appended claims.

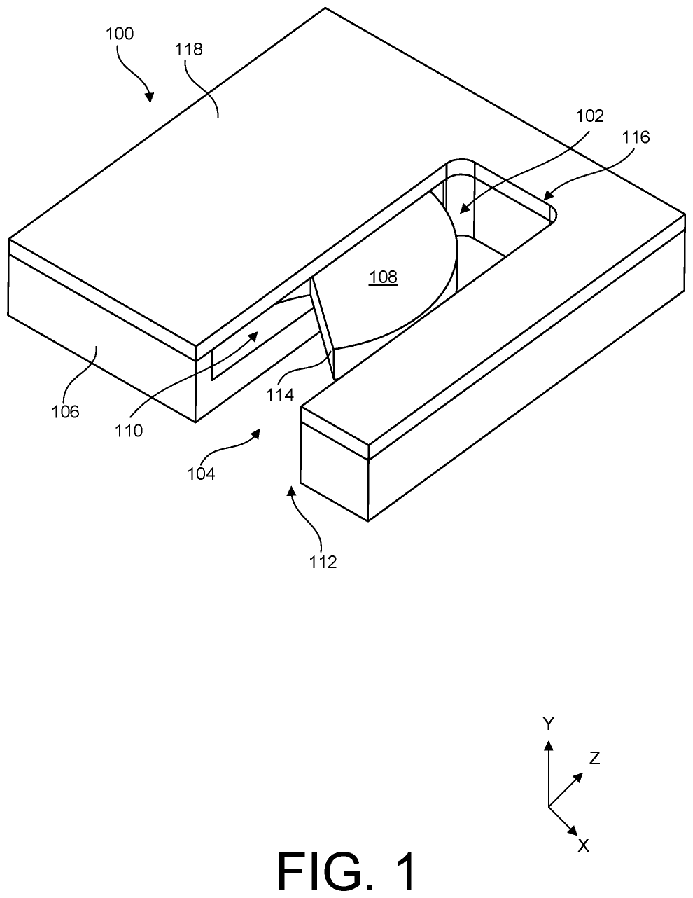

FIG. 1 illustrates an example storage device 100 including a latching mechanism 102 that is used to secure an object within the storage device 100. As shown, the storage device 100 may generally include a square-shaped structure, however, other shapes are envisioned (e.g., circular, rectangular, hexagonal, etc.). The storage device 100 is shown including a channel 104 that is formed at least in part by a housing 106. The latching mechanism 102 may include or represent a rotatable member 108 that couples to the housing 106 and is rotatable (e.g., about the Y-axis) to transition the latching mechanism 102 between a first position (e.g., unlocked state) and a second position (e.g., locked state). As shown in FIG. 1, the latching mechanism 102 is in the first position.

The rotatable member 108 includes a notch 110 that is configured to receive a portion of an object. For example, a shaft, handle, or other portion of the object may be placed through an opening 112 of the channel 104 (formed by the housing 106) and within the notch 110. Pushing on the object (e.g., Z-direction) pushes the object against a first sidewall 114 of the notch 110 and causes the rotatable member 108 to rotate (e.g., counterclockwise about the Y-axis). In doing so, the object is advanced is a direction towards an end 116 of the channel 104 as the rotatable member 108 rotates. At this position, in the locked state, the object is secured within the storage device 100.

The storage device 100 is further shown including a cover 118 that is at least partially disposed over the housing 106 and/or the rotatable member 108. In some instances, the cover 118 assists in securing the rotatable member 108 to the housing 106. For example, as will be explained in detail herein, the housing 106 may include a receptacle configured to receive the rotatable member 108. The cover 118 at least partially encloses the rotatable member 108 to prevent the rotatable member 108 disengaging from the housing 106. Additionally, the cover 118 may include a corresponding channel to align with the channel 104 of the housing 106.

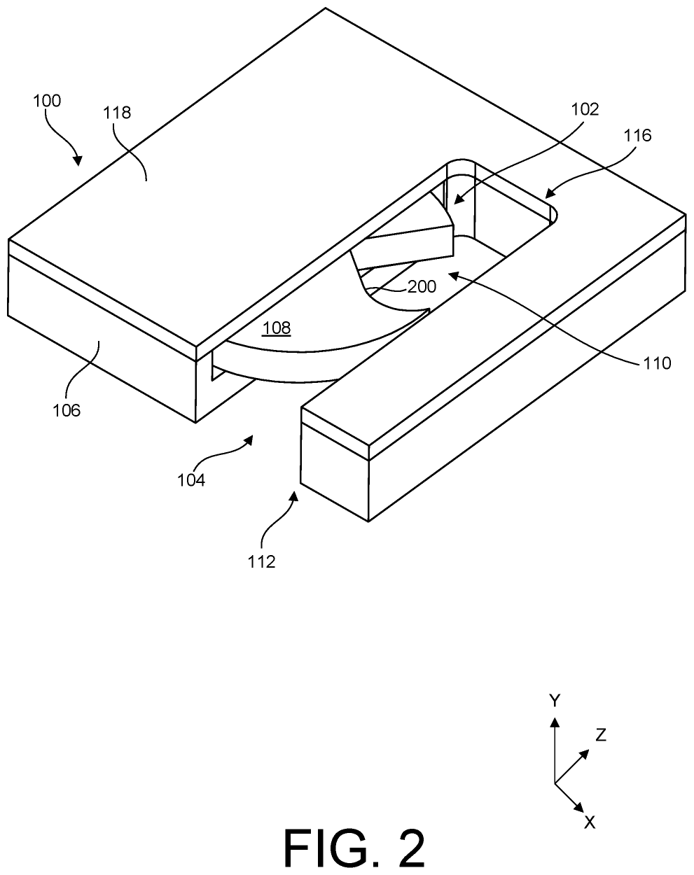

FIG. 2 illustrates the storage device 100 and the latching mechanism 102 in the second position. As shown, in comparison to FIG. 1, the latching mechanism 102 is rotated in the counterclockwise direction to secure the object. At this position, the object may be secured within the storage device 100 via the notch 110 and sidewalls (or surfaces) of the channel 104.

To move the latching mechanism 102 to the first position, such the object may be removed, the object within the storage device 100 may be pulled. Pulling on the object (e.g., in an opposite Z-direction) pulls the object against a second sidewall 200 of the notch 110 and causes the rotatable member 108 to rotate (e.g., clockwise about the Y-axis). In doing so, the object is advanced a direction towards the opening 112 of the channel 104. At this position, in the unlocked state, the object is capable of being removed from the storage device 100 and out of the channel 104.

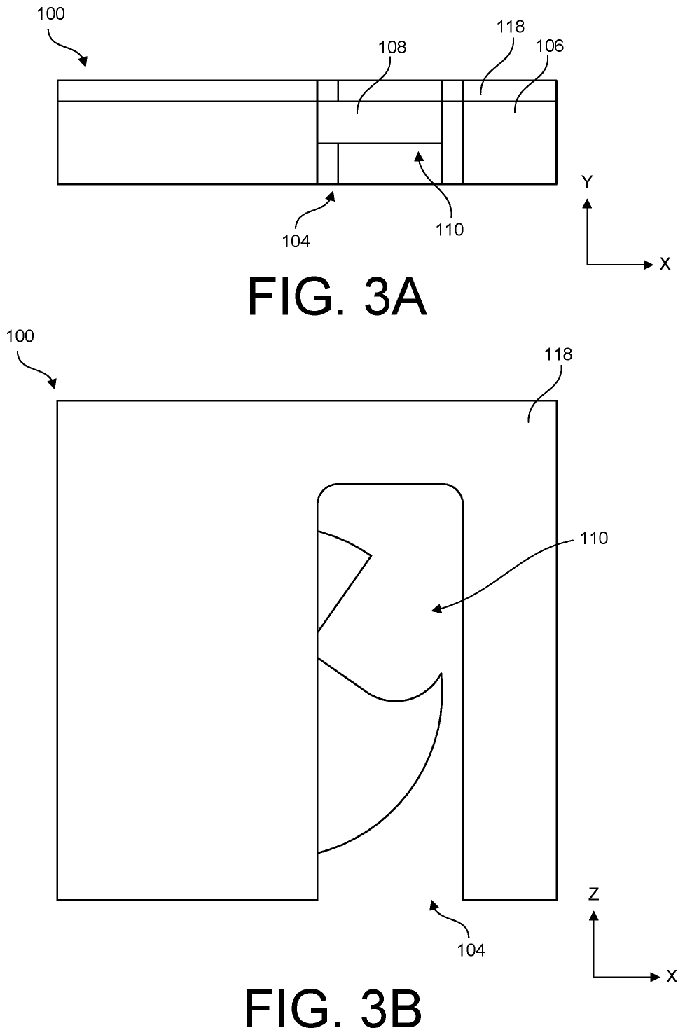

FIG. 3A illustrates an end view of the storage device 100. In some instances the view shown in FIG. 3A represents a front view of the storage device 100. The rotatable member 108 is shown at least partially residing within the channel 104 for receiving the object and securing the object within the storage device 100. For example, being as the notch 110 of the rotatable member 108 extends into the channel 104, the object may be pushed and pulled against the first sidewall 114 and the second sidewall 200 of the notch 110, respectively, to move the rotatable member 108. The cover 118 is shown coupled to a top of the housing 106, for example, to secure the rotatable member 108 to the housing 106.

FIG. 3B illustrates an end view of the storage device 100. In some instances, the view shown in FIG. 3B represents a top view of the storage device 100. The storage device 100 in FIG. 3B is shown in the second position. In the second position, the object is secured within the storage device 100, via an engagement of the object within the notch 110 and against one or more sides of the channel 104.

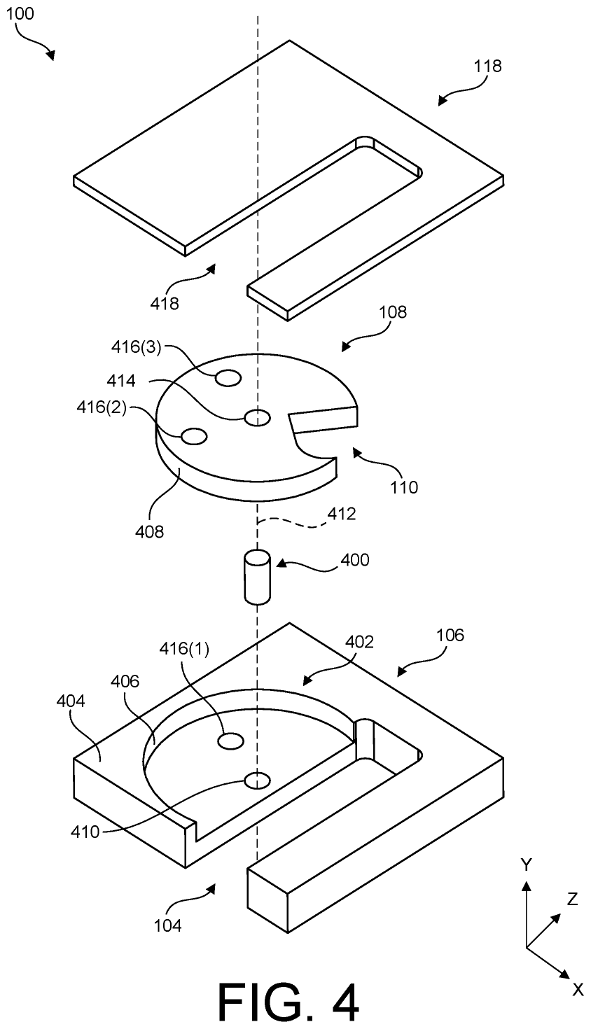

FIG. 4 illustrates an exploded view of the storage device 100, showing the housing 106, the rotatable member 108, the cover 118, and a pin 400 about which the rotatable member 108 is configured to rotate.

The housing 106 includes a receptacle 402 for receiving at least a portion of the rotatable member 108 and within which the rotatable member 108 rotates. The receptacle 402 is shown being semi-circular in shape for receiving a corresponding shape of the rotatable member 108. In some instances, the receptacle 402 is formed in a top surface 404 of the housing 106. Additionally, the receptacle 402 is defined, at least in part, by a sidewall 406. When the rotatable member 108 is engaged within the receptacle 402, an outer periphery 408 of the rotatable member 108 resides adjacent to the sidewall 406 (e.g., within the sidewall 406). The receptacle 402 is also shown being open to the channel 104 such that the notch 110 (or other portions of the rotatable member 108) is capable of extending into the channel 104 for engaging the object within the channel 104. A depth of the receptacle 402, in some instances, extends through less than an entirety of a thickness of the housing 106 (Y-direction).

The housing 106 is shown including a socket 410 for receiving the pin 400. The pin 400 additionally couples or engages with the rotatable member 108. The rotatable member 108 rotates about a rotational axis 412 that extends through the socket 410 and a passage 414 of the rotatable member 108. As such, the rotatable member 108 may rotate about the pin 400. For example, the pin 400 may be placed within the socket 410 and the rotatable member 108 (e.g., the passage 414) may be placed over the pin 400, such that the rotatable member 108 rotates about the pin 400 and within the receptacle 402. In some instances, the pin 400 remains stationary within the socket 410 as the rotatable member 108 rotates, or the pin 400 may rotate with the rotatable member 108.

Moreover, the cover 118 is secured to the housing 106 for enclosing the rotatable member 108 and coupling the rotatable member 108 to the housing 106. In doing so, the cover 118 secures the rotatable member 108 within the housing 106 and prevents separation of the rotatable member 108 from the housing 106 (e.g., in the Y-direction). As shown, the cover 118 includes a cutout 418 that at least partially defines the channel 104. In some instances, the housing 106 and the cover 118 include a similar shape, profile, or perimeter such that the cover 118 may extend over the top surface 404 of the housing 106. However, the cover 118 may include a different shape compared to the housing 106, or may be disposed over less than an entirety of the top surface 404 of the housing 106. Additionally, in some instances, the cover 118 may be omitted from the storage device 100. In such instances, the pin 400 may be secured within the socket 410 (e.g., press-fit, snap-fit, adhesives, fasteners, etc.) and the rotatable member 108 may be secured to the pin 400 (e.g., press fit).

In some instances, magnetic elements 416 are configured to secure the latching mechanism 102 in the first position and the second position. The magnetic elements 416 may be disposed on, in, and/or within the housing 106 and the rotatable member 108. For example, the housing 106 is shown including a first magnetic element 416(1) residing within the receptacle 402 (e.g., internal to the sidewall 406). The first magnetic element 416(1) may reside or be embedded within a receptacle formed in the housing 106. For example, a passage may be formed in the housing 106, and the first magnetic element 416(1) may reside within the passage.

The rotatable member 108 includes corresponding magnetic elements that engage with the first magnetic element 416(1). For example, the rotatable member 108 may include a second magnetic element 416(2) and a third magnetic element 416(3) that engage, respectively, within the first magnetic element 416(1). The second magnetic element 416(2) engages with the first magnetic element 416(1) in the first position, and the third magnetic element 416(3) engages with the first magnetic element 416(1) in the second position. The second magnetic element 416(2) and the third magnetic element 416(3) may respectively reside within passages that extend at least partially through a thickness of the rotatable member 108.

In the first position, the first magnetic element 416(1) and the second magnetic element 416(2) engage with one another to hold the rotatable member 108 in the first position. However, as noted above, the object may press against the first sidewall 114 of the notch 110 to transition the rotatable member 108 to the second position. The rotatable member 108 therefore rotates about the rotational axis 412 in a counterclockwise direction to transition to the second position. In the second position, the third magnetic element 416(3) engages with the first magnetic element 416(1) to hold the rotatable member 108 in the second position. To remove the object, the object may pull against the second sidewall 200 of the notch 110 to transition the rotatable member 108 to the first position. In doing so, the rotatable member 108 rotates about the rotational axis 412 in a clockwise direction to transition to the first position. As such, the rotatable member 108 rotates such that the first magnetic element 416(1) engages with the second magnetic element 416(2) and the third magnetic element 416(3) in the first position and the second position, respectively.

Although the magnetic elements 416 are shown being disposed on certain portions of the housing 106 and the rotatable member 108, respectively, the magnetic elements 416 may be disposed elsewhere. For example, the first magnetic element 416(1) may be disposed on the cover 118, elsewhere within the receptacle 402, external to the receptacle 402, on the sidewall 406, and so forth. The second magnetic element 416(2) and/or the third magnetic element 416(3) may additionally or alternatively be disposed elsewhere on the rotatable member 108, such as on the outer periphery 408 of the rotatable member 108. Additionally, the storage device 100 may include more magnetic elements 416 than shown. As illustrated, the magnetic elements 416 may be circular in shape, however, other shapes are envisioned. For example, the magnetic elements 416 may be square shaped.

In some instances, a lock may be attached to the storage device 100 to secure the object therein. By way of example, the housing 106, the rotatable member 108, and/or the cover 118 may include passages that align in the locked state. In the locked state, a lock, such as a bar of the lock, may be placed through the passages and therein locked. As a result, the rotatable member 108 may be restricted from opening to prevent release of the object. In other instances, a bar may be secured over the opening 112 of the channel 104 to prevent the object being removed. Other locks, however, are envisioned to further secure the object within the storage device 100.

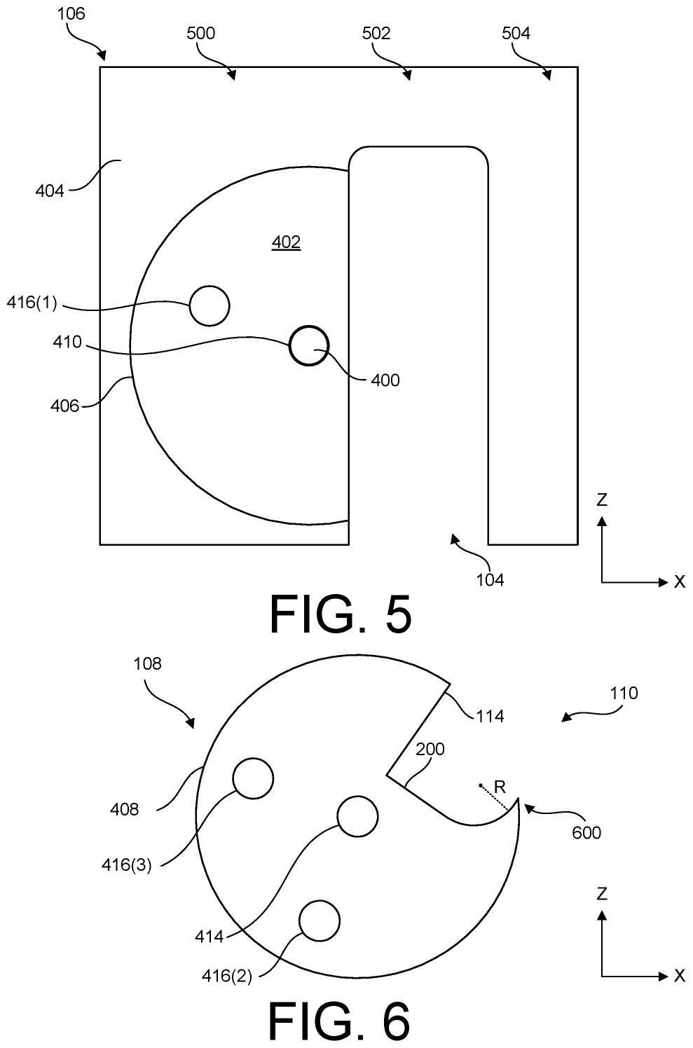

FIG. 5 illustrates an end view of the housing 106 which, in some instances, represents a top of the housing 106. The housing includes the top surface 404 that at least partially defines the receptacle 402. As introduced above, the receptacle 402 may be at semi-circular in shape for receiving a circular shape of the rotatable member 108. However, the receptacle 402 and/or the rotatable member 108 may be differently shaped than shown. In some instances, the receptacle 402 and the rotatable member 108 may include different shapes than one another. For example, the receptacle 402 may be square shaped and the rotatable member 108 may be circular shaped.

The pin 400 is shown coupled to the housing 106, at a location within the receptacle 402 (within the socket 410). Additionally, the first magnetic element 416(1) is shown coupled to the housing 106, at a location within the receptacle 402. In some instances, the first magnetic element 416(1) may be located closer to the sidewall 406 of the receptacle 402, shaped apart from the pin 400, in a direction away from the channel 104. However, the first magnetic element 416(1) may be located elsewhere, whether at another annular location disposed around the pin 400, on the sidewall 406, on the cover 118, and so forth. The location of the first magnetic element 416(1) may be complimentary to engage with a corresponding location of the second magnetic element 416(2) and the third magnetic element 416(3).

In some instances, the housing 106 (or a body thereof) is formed at least in part by a first portion 500, a second portion 502, and/or a third portion 504. The first portion 500 may include the receptacle 402 and define a first side of the channel 104. The second portion 502 may extend between the first portion 500 and the third portion 504, and defines a second side of the channel 104. The third portion 504 extends from the second portion 502 and defines a third side of the channel 104. The cover 118, although not described, may include a corresponding shape and features for mating with and adjoining to the housing 106 (or the portions thereof).

Although the receptacle 402 is shown at a particular location on or within the housing 106, the receptacle 402 may be positioned elsewhere (e.g., spaced upward or downward in the Z-direction, spaced sideways in the X direction, etc.). Additionally, although the first portion 500, the second portion 502, and the third portion 504 are shown including certain sizes and/or shapes, the first portion 500, the second portion 502, and/or the third portion 504 may include different shapes and/or sizes compared to one another.

FIG. 6 illustrates the rotatable member 108. As shown, the rotatable member 108 may include a circular shape for being received within the receptacle 402. The passage 414 is disposed through the rotatable member 108 such that the pin 400 may reside at least partially within the passage 414 to provide rotational movement to the rotatable member 108.

The second magnetic element 416(2) and the third magnetic element 416(3) are shown embedded within or coupled to the rotatable member 108. In some instances, the second magnetic element 416(2) and the third magnetic element 416(3) are embedded within passages that extend at least partially through the rotatable member 108. As illustrated, the second magnetic element 416(2) and the third magnetic element 416(3) may be located more proximal to the outer periphery 408 of the rotatable member 108 than the passage 414.

In some instances, the second magnetic element 416(2) and the third magnetic element 416(3) are oriented at substantially 90 degrees from one another (relative to the rotational axis 412). Between the first position and the second position, the rotatable member 108 may rotated by substantially 90 degrees. However, the rotatable member 108 may rotated by more than or less than 90 degrees between the first position and the second position. For example, the rotatable member 108 may rotate 30 degrees, 60 degrees, 100 degrees, and so forth. Additionally, the second magnetic element 416(2) and the third magnetic element 416(3) may be spaced apart from the rotational axis 412 by the same or different amount. The second magnetic element 416(2) and the third magnetic element 416(3), in other words, may be disposed on the same or different arcs from the rotational axis 412.

The rotatable member 108 is further shown including the notch 110 having the first sidewall 114 and the second sidewall 200. The first sidewall 114 and the second sidewall 200 may represent a portion of the outer periphery 408. In some instances, the first sidewall 114 and the second sidewall 200 are oriented at substantially 90 degrees relative to one another. However, the first sidewall 114 and the second sidewall 200 may be oriented differently (e.g., 100 degrees). In some instances, edges or surfaces of the first sidewall 114 and/or the second sidewall 200 are tapered or chamfered to reduce damage (e.g., scrapping) to the object.

Additionally, as shown, the second sidewall 200 may include a flare, projection, or other lip 600. The lip 600 curls in a direction towards the outer periphery 408 of the rotatable member 108. In some instances, the lip 600 may include a radius R. The radius R may correspond to a radius of a shaft, bar, strut, or other member in which the storage device 100 is capable of receiving. When the object engages with the second sidewall 200 to transition the rotatable member 108 to the second position, the lip 600 (or the radius R) may serve to transfer the motion to the rotatable member 108. In some instances, the radius R is sized to accommodate the object.

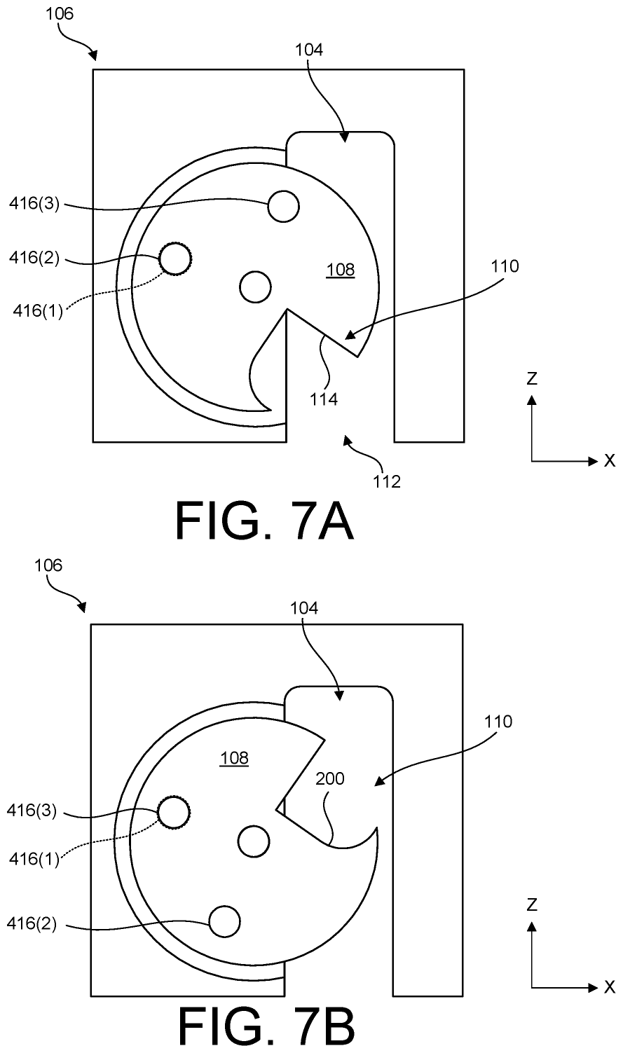

FIGS. 7A and 7B respectively illustrate the first position and the second position of the rotatable member 108. In FIGS. 7A and 7B, the cover 118 is removed to illustrate the operation of the rotatable member 108.

In FIG. 7A, the notch 110 is shown oriented in a direction towards the opening 112 of the channel 104 to receive the object. In this position, the storage device 100 is in an open or unlocked state. Additionally, the second magnetic element 416(2) engages with the first magnetic element 416(1). As shown, at least a portion of the notch 110 resides within the receptacle 402, while another portion of the notch 110 resides within the channel 104. Here, the notch 110 is capable of receiving or otherwise engaging with the object.

As also shown in FIG. 7A, the first magnetic element 416(1) is shown in dashed lines to indicate a position of the first magnetic element 416(1) vertically beneath the rotatable member 108. To transition to the second position, the object may press against the first sidewall 114 of the rotatable member 108, causing the rotatable member 108 to rotate about the rotational axis 412 in a counterclockwise direction (about the Y-axis). When sufficient force is applied, the second magnetic element 416(2) disengages from the first magnetic element 416(1) and rotates in the counterclockwise direction as well. In some instances, the attraction between the first magnetic element 416(1) and the second magnetic element 416(2) maintains the rotatable member 108 in the first position. Moreover, in the first position, the rotatable member 108 may be capable of rotating in the clockwise direction when no object resides within the notch 110.

In FIG. 7B, the notch 110 is shown oriented in a direction away from the opening 112, such as towards the second side or the third side of the channel 104. In this position, the storage device 100 is in a closed or locked state. Additionally, the third magnetic element 416(3) engages with the first magnetic element 416(1). The first magnetic element 416(1) is in dashed lines to indicate a position of the first magnetic element 416(1) vertically beneath the rotatable member 108 (Y-direction into page). To transition to the first position, the object may press against the second sidewall 200 of the rotatable member 108, causing the rotatable member 108 to rotate about the rotational axis 412 in a clockwise direction (about the Y-axis). When sufficient force is applied, the third magnetic element 416(3) disengages from the first magnetic element 416(1) and rotates in the clockwise direction as well. The attraction between the first magnetic element 416(1) and the third magnetic element 416(3) maintains the rotatable member 108 in the first position.

In some instances, the housing 106 may include additional magnetic element(s) that engage with the second magnetic element 416(2) and/or the third magnetic element 416(3). For example, the housing 106 may include a fourth magnetic element that engages with the third magnetic element 416(3) in the first position. This may increase a force required to transition the rotatable member 108 from the first position to the second position (e.g., by separate sets of magnetic elements). Additionally, or alternatively, the housing 106 may include a fifth magnetic element that engages with the second magnetic element 416(2) in the second position. This may increase a force required to transition the rotatable member 108 from the second position to the first position (e.g., by separate two sets of magnetic elements).

As shown, in the first position, the third magnetic element 416(3) may be at least partially disposed within the channel 104. However, the third magnetic element 416(3) (as well as the second magnetic element 416(2)) may be located differently than shown such that the third magnetic element 416(3) is not visible (once the cover 118 couples to the housing 106). Additionally, and as shown, a first portion of the rotatable member 108 may be disposed within the receptacle 402, while a second portion of the rotatable member 108 may be disposed within the channel 104 (or external to the receptacle 402). In some instances, the first portion may be larger than the second portion. As such, in some instances, a majority, for example, of the rotatable member 108 may reside within the receptacle 402.

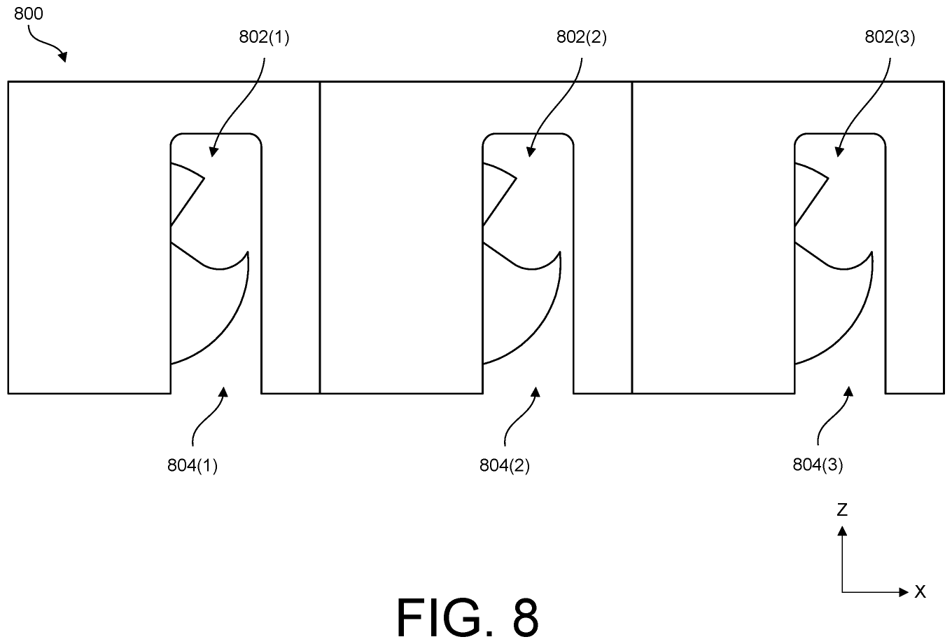

FIG. 8 illustrates an example storage device 800 having multiple latching mechanisms 802 for storing, holding, or otherwise securing an object, respectively. The storage device 800 may be similar to the storage device 100 discussed above, however, as shown, the storage device 800 includes respective channels 804 for securing objects therein. The latching mechanisms 802 may be similar to the latching mechanisms 102 as discussed above.

For example, the storage device 800 may include a first latching mechanism 802(1) for securing a first object within a first channel 804(1), a second latching mechanism 802(2) for securing a second object within a second channel 804(2), and a third latching mechanism 802(3) for securing a third object within a third channel 804(3). In some instances, the latching mechanisms 802 may be embodied within a single unibody housing or structure. However, the latching mechanisms 802 may operate independently of one another to securing objects therein. In other aspects, the storage device 800 may be similar to the storage device 100.

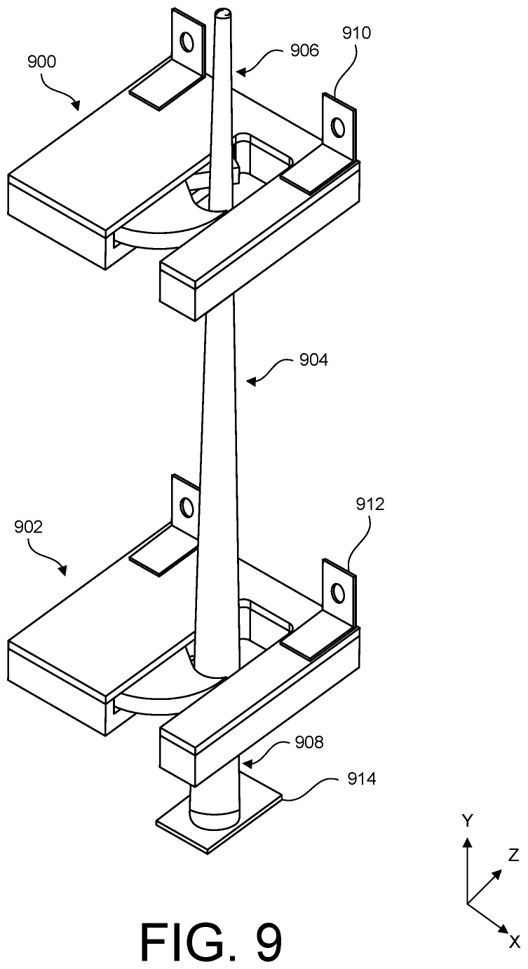

FIG. 9 illustrates a first storage device 900 and a second storage device 902 securing an object 904, such as a pool cue. The first storage device 900 and the second storage device 902 may be similar to the storage device 100 and/or the storage device 800 as discussed above.

The first storage device 900 is shown disposed vertically above the second storage device 902 (Y-direction). The first storage device 900, or a first latching mechanism therein, is configured to receive and secure a first end 906 of the object 904. The second storage device 902, or a second latching mechanism therein, is configured to receive and secure an opposite second end 908 of the object 904. Each of the first storage device 900 and the second storage device 902 may operate independently, between a locked state and an unlocked state, to secure the first end 906 and the second end 908 of the object, respectively. As such, and as shown, the object 904 may be disposed vertically on a wall, for example.

In some instances, the first storage device 900 and the second storage device 902 include mechanisms for securing to a wall or other mountable surface. For example, the first storage device 900 may include one or more first flanges 910 having passages extending therethrough, and through which fasteners are disposed. Likewise, the second storage device 902 may include one or more second flanges 912 having passages extending therethrough and through which fasteners are disposed. The fasteners, for example, may be secured into wood, metal, drywall, plastic, and/or other materials. Additionally, or alternatively, the first storage device 900 and/or the second storage device 902 may be secured using adhesives (e.g., double sided tape), hangers, and so forth. Moreover, the first storage device 900 and/or the second storage device 902 may include additional structures for securing the first storage device 900 and/or the second storage device 902 to surfaces.

Although FIG. 9 illustrates the first storage device 900 and the second storage device 902 oriented in a particular manner, the first storage device 900 and/or the second storage device 902 may be oriented differently. For example, the first storage device 900 and the second storage device 902 may be oriented to dispose the object 904 horizontally on the wall or at another angle along the wall. More than two storage devices, such as the first storage device 900 and the second storage device 902 may be used to secure the object 904. For example, a third storage device may also be disposed between the first storage device 900 and the second storage device 902, so as to secure a middle portion of the object 904. However, it is to be understood that the amount of storage devices utilized to secure the object 904 (or other objects) may be based at least in part on a size of the object 904, a weight of the object 904, a shape of the object 904, dimensions of the object 904, and so forth. Moreover, components of the first storage device 900 and the second storage device 902 may be sized or include corresponding sizes for securing the object 904. For example, the first end 906 of the object 904 may include a smaller cross-sectional size (e.g., diameter) than the second end 908 of the object 904. Here, a rotatable member within a first latching mechanism of the first storage device 900 may include a smaller notch as compared to a notch within a rotatable member of a second latching mechanism of the second storage device 902. In some instances, a size, and therefore a strength of the magnetic elements, may be based at least in part on the object 904 secure.

In some instances, other members, mechanism, supports, and the like may be used for securing (or holding) the object 904 within the first storage device 900 and the second storage device 902. For example, a shelf 914 may support a butt of the second end 908. The shelf 914 may carry or support a portion of a weight of the object 904. However, in some instances, the object 904 may be suspended (e.g., hang) within the first storage device 900 and/or the second storage device 902, or may rest against other surfaces within an environment (e.g., floor).

Although the object 904 is shown and described as a pool cue, the object 904 may include other items capable of being stored. For example, cleaning utensils (e.g., broom, mop, etc.), yard tools (e.g., rake, shovel, etc.), tools (e.g., hammer, screwdriver etc.), piping, and the like may be secured within the first storage device 900 and/or the second storage device 902 (or other storage devices).

In some instances, and as noted above, the first storage device 900 and/or the second storage device 902 may include locks that prevent rotation of the latching mechanism(s) within the first storage device 900 and/or the second storage device 902. Such locks may further secure the object 904 within the first storage device 900 and/or the second storage device 902. Moreover, other mechanisms (e.g., bars, cables, codes, etc.) may be used to lock the first storage device 900 and/or the second storage device 902.

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

1. A storage device comprising:
a housing defining a channel, a receptacle, and a first passage, the housing including a first magnetic element;
a rotatable member positioned within the receptacle, the rotatable member being rotatably coupled to the housing and moveable between a first position and a second position, the rotatable member including:
a second magnetic element that engages with the first magnetic element in the first position,
a third magnetic element that engages with the first magnetic element in the second position,
a notch, and
a second passage;
a cover at least partially disposed over the housing and the rotatable member; and
a pin at least partially disposed within the first passage and at least partially disposed within the second passage, the rotatable member being rotatable about an axis extending though the pin.

2. The storage device of claim 1, wherein the rotatable member is at least partially disposed within the receptacle and at least partially within the channel.

3. The storage device of claim 1, wherein the first magnetic element is disposed within the receptacle.

4. The storage device of claim 1, wherein the rotatable member is configured to rotate substantially ninety degrees between the first position and the second position.

5. The storage device of claim 1, wherein:
the notch is configured to receive a portion of an object; and
in the second position, the object is secured within the storage device via the notch and one or more sidewalls of the channel.

6. The storage device of claim 1, wherein:
from the first position to the second position, the rotatable member is configured to rotate in a first direction; and
from the second position to the first position, the rotatable member is configured to rotate in a second direction that is opposite the first direction.

7. An apparatus comprising:
a housing having a first magnetic element; and
a latching mechanism coupled to the housing, the latching mechanism including a second magnetic element and a third magnetic element, the latching mechanism being configured to rotate between a first position in which the first magnetic element and the second magnetic element engage, and a second position in which the first magnetic element and the third magnetic element engage.

8. The apparatus of claim 7, wherein:
the first position corresponds to an unlocked state of the latching mechanism in which an object is capable of being removed from the apparatus; and
the second position corresponds to a locked state of the latching mechanism in which the object is secured within the apparatus.

9. The apparatus of claim 7, wherein the latching mechanism includes a rotatable member having a notch, the notch being configured to receive at least a portion of an object secured within the apparatus.

10. The apparatus of claim 7, wherein:
the latching mechanism is configured to rotate in a first direction, from the first position to the second position; and
the latching mechanism is configured to rotate in a second direction, opposite the first direction, from the second position to the first position.

11. The apparatus of claim 7, wherein:
the housing incudes a receptacle and a channel; and
the latching mechanism is at least partially disposed in the receptacle and at least partially disposed in the channel.

12. The apparatus of claim 11, wherein:
the latching mechanism includes a rotatable member having the second magnetic element and the third magnetic element; and
the rotatable member is rotatable within the receptacle.

13. The apparatus of claim 12, further comprising a cover at least partially disposed over the housing and at least partially disposed over the rotatable member.

14. The apparatus of claim 12, wherein the housing include a first passage and the rotatable member includes a second passage, further comprising a pin, wherein:
the pin at least partially extends through or is at least partially disposed within the first passage; and
the pin at least partially extends through or is at least partially disposed within the second passage.

15. A device comprising:
a housing including a channel; and
a latching mechanism rotatably coupled to the housing between a first position and a second position, the latching mechanism including a notch that receives a portion of an object in the first position, and rotates to the second position to secure the object within the channel.

16. The device of claim 15, wherein:
the housing includes a first magnetic element; and
the latching mechanism includes a second magnetic element and a third magnetic element, the second magnetic element engaging within the first magnetic element in the first position, the third magnetic element engaging with the first magnetic element in the second position.

17. The device of claim 16, wherein:
an engagement between the first magnetic element and the second magnetic element prevents rotation of the latching mechanism to the second position;
application of a first force overcomes the engagement between the first magnetic element and the second magnetic element to permit rotation of the latching mechanism to the second position;
an engagement between the first magnetic element and the third magnetic element prevents rotation of the latching mechanism to the first position; and
application of a second force overcomes the engagement between the first magnetic element and the third magnetic element to permit rotation of the latching mechanism to the first position.

18. The device of claim 17 wherein:
the latching mechanism includes a rotatable member; and
the second magnetic element and the third magnetic element are disposed at least one of on, within, or in the rotatable member.

19. The device of claim 15, wherein:
the housing further includes a receptacle; and
the latching mechanism is at least partially disposed within the receptacle and at least partially within the channel.

20. The device of claim 19, wherein the housing further includes a second channel, further comprising a second latching mechanism rotatably coupled to the housing between a third position and a fourth position, the second latching mechanism including a second notch that receives a portion of a second object in the third position, and rotates to the fourth position to secure the second object within the second channel.
